(19) United States
(12) Patent Application Publication
(10) Pub. No.: US 2019/0165342 A1
(43) Pub. Date: May 30, 2019

(54) THIN-FILM BATTERY WITH ADHESIVE LAYER

(71) Applicant: ITN Energy Systems, Inc., Littleton, CO (US)

(72) Inventors: Brian BERLAND, Littleton, CO (US); John OLENICK, Buffalo, NY (US); Kathy OLENICK, Buffalo, NY (US); David CAREY, Austin, TX (US)

(73) Assignee: ITN Energy Systems, Inc., Littleton, CO (US)

(21) Appl. No.: 16/317,802

(22) PCT Filed: Jul. 13, 2017
(86) PCT No.: PCT/US2017/042000

§ 371 Date: Jan. 14, 2019

Related U.S. Application Data
(60) Provisional application No. 62/480,902, filed on Apr. 3, 2017.
(60) Provisional application No. 62/361,949, filed on Jul. 13, 2016.

(51) Int. Cl. H01M 2/08; H01M 10/0585; H01M 2/02; H01M 6/40

(52) U.S. Cl. CPC H01M 2/08; H01M 6/40; H01M 2/0207; H01M 10/0585

(57) ABSTRACT

A thin-film battery that includes an adhesive layer is provided. The thin-film battery may have active layer (such as an anode, a cathode, an electrolyte, an anode current collector, and a cathode current collector) and a thin-film substrate made of ceramic or glass. The adhesive layer may be deposited over a portion of the active layer and the substrate. This may provide for a more stable, flexible, and mechanically sound thin-film battery.

### RELATED APPLICATIONS

This application is being filed on 13 Jul. 2017, as a PCT International patent application, and claims priority to U.S. Provisional Application No. 62/361,949 filed Jul. 13, 2016, and to U.S. Provisional Patent Application No. 62/480,902 filed Apr. 3, 2017, the entirety of each application is incorporated herein by reference.

### BACKGROUND

This application generally relates to creating a solid-state thin-film rechargeable battery that may be used for integration with medical implants, smart wearable devices, and other electronics products.

Solid state batteries often include packaging to protect the battery from reacting with the environment (e.g., reacting with oxygen, water, and/or other reactive components in the ambient environment). The current technology uses sealed metal foil or laminated pouches that are a separate component from the battery. These pouches take up valuable space, which reduces the total energy to volume ratio of a battery. This is particularly true in smaller scale batteries used in flexible electronics, smart wearables, medical implants.

Some thin batteries use inflexible components, making them unsuitable for a variety of applications, e.g. wearables. Traditional thin batteries cannot tolerate point loads, or have unsuitable flex radii.

It is with respect to these and other considerations that embodiments have been made. Also, although relatively specific problems have been discussed, it should be understood that the embodiments should not be limited to solving the specific problems identified in the introduction.

### SUMMARY

The technology described herein relates to solid-state batteries (“SSBs”). Aspects of the technology use a combination of thin-film insulating substrates and adhesive materials as the packaging of the battery to protect the battery materials from reactions with the environment. For example, a SSB may consist of a single solid-state battery cell deposited on a thin-film substrate, a second thin substrate serving as the cover, and a thin adhesive material between the two substrates. In aspects, the adhesive material may cover all or portions of the cell (e.g., the anode, the electrolyte, and the cathode) of the thin-film battery. Indeed, the adhesive may provide structural support to aid in reducing cracking and/or maintaining a connection when the battery is flexed or otherwise stressed. The adhesive material may further have barrier properties to protect the deposited solid-state battery from the ambient environment, which may occur at the exposed edges between the substrates. Vias (e.g., electrical connections) may facilitate electrical communication between thin-film battery layers of a thin-film batteries. In aspects of the technology, a battery includes a substantially planar thin-film substrate having a top-side and a bottom-side. The battery also includes a cell disposed on the top-side of the substrate, the cell comprising a cathode current collector, a cathode, an anode current collector, an anode, and an electrolyte. The cell has a top-side in aspects. The battery further includes an adhesive layer disposed on and coupled to at least a portion of the top-side of the cell. The battery may also include a second substrate disposed on a top-side of the adhesive layer. The second substrate may additionally have a top-side. The second cell may be disposed on the second top-side. The second cell may include a second cathode, a second cathode current collector, a second anode current collector, a second anode, and a second electrolyte. The battery may also include a via that electrically couples the anode current collector or the cathode current collector to the second cathode collector or the second anode collector. The via may be filled with a conductive material. Additionally, a third cell may be disposed on the bottom-side of the thin-film substrate. The third cell may be in electrical communication with the cell. In aspects, the adhesive layer is at least one of an epoxy, a urethane, a rubber, a flexible sealant, or an adhesive. Additionally, the cathode may be at least one of LiCoO₂, LiVO₃, LiMn₂O₄, and LiFePO₄. The anode current collector or the cathode current collector may be exposed at an edge, and an end-cap metallization layer may be disposed on the exposed anode current collector or the cathode current collector. Additionally, the battery may have flex radii of greater than 5 millimeters.

In another aspect of the technology, a battery may include a substantially planar thin-film substrate having a top-side, a bottom-side, and an edge. The battery may additionally include a cathode current collector having a cathode current collector top-side and a cathode current collector bottom-side, the cathode current collector bottom-side disposed on and coupled to at least a portion of the top-side of the thin-film substrate. The battery may additionally include a cathode having a cathode top-side and a cathode bottom-side. The cathode bottom-side may be disposed on and coupled to at least a portion of the cathode current collector top-side. The battery may further include an electrolyte layer having an electrolyte layer top-side and an electrolyte layer bottom-side. The electrolyte layer bottom-side may be disposed on and coupled to at least a portion of the cathode top-side. The battery may also include an anode having an anode top-side and an anode bottom-side. The anode bottom-side may be disposed on and coupled to at least a portion of the electrolyte layer top-side. The battery may additionally include an anode current collector having an anode current collector top-side and an anode current collector bottom-side. The anode current collector bottom side may be disposed on and coupled to at least a portion of the anode top-side. The battery may also include an adhesive layer having an adhesive layer-top side and an adhesive layer bottom side. The adhesive layer bottom-side may be disposed on and coupled to at least a portion of the anode current collector top-side, the cathode current collector top-side, and the top-side of the thin-film substrate. In aspects, a second thin-film substrate has a second-top side and a second bottom-side, and the second bottom-side is disposed on and coupled to at least a portion of the top-side of the adhesive layer top-side. In aspects, a battery cell is disposed on and coupled to the second top-side, and the battery cell is in electronic communication with the anode current collector or the cathode current collector, and the electronic communication is facilitated by a via. In aspects, the via includes a pathway that extends from at least the anode current collector or the cathode current collector, through the adhesive layer, and through the second thin-film substrate such that the via is in electrical contact with a current collector of the battery cell. The via may be a stepped via. The via may also include a metallized end-cap that is coupled to the edge of the thin-film substrate. The anode collector or the cathode collector may extend along the top-side of the thin-film substrate to the edge of the thin-film substrate such that the anode collector or the cathode collector is in electrical contact with the metalized end-cap. The adhesive layer may be at least one of an epoxy, a urethane, a rubber, a silicone, a polyimide, a cyanoacrylate, or an acrylic. The cathode may be at least one of LiCoO₂, LiVO₃, LiMn₂O₄, and LiFePO₄. The battery may have a flex radii of greater than 5 millimeters. The battery of claim may have a substrate that comprises yttria stabilized zirconia.

Aspects of the technology further include a method of creating a solid state battery. The method may include providing a substrate. The substrate has a top side and a bottom side. The method may further include depositing an anode current collector, an anode layer, an electrolyte layer, and a cathode current collector, and a cathode layer on the top-side of the substrate to form a first cell. The first cell may have a top-side and a bottom-side. The method may further include placing an adhesive layer over at least a portion of the top-side of the first cell. The method may further include sealing the first cell by adhering an element to the top side of the first cell. The adhesive layer may form a seal with the element. The adhesive layer may cover at least a portion of each of the anode, the anode current collector, and the cathode current collector. The method may further include the adhesive layer covering at least 90% of the anode. The element may be a thin-film battery, the thin-film battery may include a plurality of cells, Each cell of the plurality of cells may be deposited on a thin-film substrate. The battery may have a flex radii of greater than 5 millimeters. The first cell may be in electronic communication with the plurality of cells through a via. The via may comprise an end-cap metallization. The adhesive layer may be at least one of an epoxy, a urethane, a rubber, a silicone, a polyimide, a cycanoacrylate, or an acrylic. The cathode may be at least one of LiCoO₂, LiVO₃, LiMn₂O₄, and LiFePO₄. The anode current collector or the cathode current collector may be exposed at an edge, and the end-cap metallization layer may be disposed on the exposed anode current collector or the cathode current collector. The battery may have a flex radii of greater than one inch.

This Summary is provided to introduce a selection of concepts in a simplified form that are further described below in the Detailed Description. This Summary is not intended to limit the technology or identify key features or essential features of the claimed subject matter, nor is it intended to be used as an aid in determining the scope of the claimed subject matter.

### BRIEF DESCRIPTION OF THE DRAWINGS

Non-limiting and non-exclusive embodiments are described with reference to the following figures.

FIG. 1 is cross-section view of an example thin-film battery with adhesive layering.

FIG. 2 illustrates a perspective view an example of a thin-film battery with adhesive layer.

FIG. 3 illustrates an exploded view of an example of a plurality of thin-film batteries in a thin-film cell stack.

FIG. 4A illustrates a cross-section view of an example of a thin-film cell stack with an adhesive layer and vias.

FIG. 4B illustrates a perspective view of an example of a thin-film cell stack with an adhesive layer and vias.

FIG. 5A illustrates a cross-section view of an example of an alternative embodiment of a thin-film cell stack with an adhesive layer and vias.

FIG. 5B illustrates a perspective view of an alternative embodiment of a thin-film cell stack with an adhesive layer and vias.

FIG. 6A illustrates a cross-section view of an example of a thin-film cell stack with a stepped via.

FIG. 6B illustrates a perspective view of an example of a thin-film cell stack with a stepped via.

FIG. 7A illustrates a cross section view of an example of a thin-film cell stack with end-cap metallization.

FIG. 7B illustrates a perspective view of an example of a thin-film cell stack with end-cap metallization.

FIG. 8 illustrates a cross section view of an embodiment of a cell stack with a dual sided substrate.

FIG. 9 is a method to produce a thin-film battery with an adhesive layer.

FIG. 10A illustrates a view of an un-flexed multi-cell, thin-film battery.

FIG. 10B illustrates a view of a flexed multi-cell, thin-film battery.

### DETAILED DESCRIPTION

Various embodiments are described more fully below with reference to the accompanying drawings and attachments, which form a part hereof, and which illustrate example embodiments. However, embodiments may be implemented in many different forms and should not be construed as limited to the embodiments set forth herein. Rather, these embodiments are provided so that this disclosure will be thorough and complete and will fully convey the scope of the embodiments to those skilled in the art. Embodiments may be practiced as methods, systems, or devices. It will be appreciated that aspects of each embodiment may be practiced in part or in whole with the other embodiments described. The following detailed description is, therefore, not to be taken in a limiting sense.

Aspects of the technology relate to thin-film solid state batteries. In aspects, the substrate of a thin-film battery serves as both the battery carrier and the sealing material. This may be accomplished by having an adhesive layer that is disposed on a top-portion of a solid state battery cell (e.g., a thin-film substrate, a cathode current collector, a cathode, an electrolyte, an anode, and an anode current collector). The adhesive layer may cover much of the top-portion of a solid state battery. That is, the adhesive layer may be deposited on top of an anode current collector, the cathode current collector, the cathode, the electrolyte, and/or the anode. Vias or pathways may be present through the anode current collector, the cathode current collector, thin-film substrate, and/or the adhesive layer. This may allow electronic communication between the cells of a solid-state battery, another solid-state battery, and/or an electronic device.

Multiple cells of a thin-film cell stack may be joined together in a variety of ways. For example, cells may be joined in parallel or series. In the case of a two cell battery stack (also referred to herein as a cell stack), the batteries may be stacked with the deposited layers facing each other or not. The adhesive layer may bind a plurality of thin-film cells together. In some examples, the substrates of at least a portion of the plurality of thin-film cells serve as the package. For example, a cell located at the top and a cell located at the bottom may each have a substrate, and the top substrate may serve as the top-side packaging of the cell and the bottom substrate may serve as the bottom-side packaging of the cell. Additionally, the adhesive layer may provide adhesive properties (e.g., allowing one battery to couple to another battery), provide mechanical stability, and electrical insulation. For example, the adhesive layer may be deposited or applied across a large surface area of a cell on a thin-film battery. This may, for some adhesives, provide greater flexibility and durability. For example, the adhesive may increase the point-load tolerance and/or the radii of flexibility for a thin-film battery, including thin-film batteries with ceramic substrates. Additionally, aspects of the technology described herein include batteries with improved water vapor transmission rates, improved thermal stability, higher operating temperatures, and greater electrical isolation.

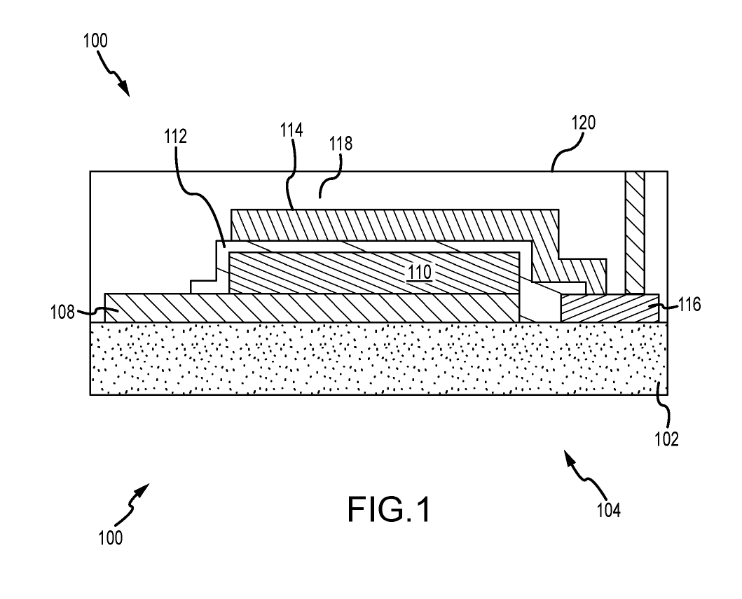

FIG. 1 is cross-section view of an example thin-film battery 100 with adhesive layering. The battery 100 may have a bottom-side 104 and a top-side 106. It will be appreciated that each layer in the battery 100, such as the substrate 102, the cathode current collector 108, the cathode 110, the electrolyte layer 112, the anode 114, the anode current collector 116, and the adhesive layer 118 will have each have a bottom-side and a top-side relatively oriented to the bottom-side 104 and the top-side 106.

As illustrated, the battery 100 includes multiple layered structures disposed on a substrate 102, which can be flexible or rigid. In examples, the substrate 102 is one of glass or ceramic. The substrate may be made of thin ceramics or glasses to prevent electrical shorting. The substrate may be selected to allow flexion when coupled to an adhesive. The substrate 102 may comprise metal oxides, which may be binary and/or complex metal oxides, and may have very low transmission of water and oxygen. In some embodiments, the substrate 102 may be yttria stabilized zirconia (YSZ), or may be alumina. The substrate 102 may further comprise dopants or additives, which may improve one or more physical or electrical properties.

A cathode current collector 108 is disposed on the top-side 106 of the substrate 102. The cathode current collector 108, which may extend horizontally beyond the other layers, is used as a contact for the cathode 110. In one embodiment the cathode current collector is gold, though it can be a variety of conductive materials such as a metal or a conductive paste or ink.

As illustrated, the cathode 110 is in direct contact with the cathode current collector 108. The cathode 110 can be a variety of materials, but is often a metal oxide. The cathode may be any currently known or future material suitable for use as a cathode in a thin-film solid state battery. In some embodiments, the cathode is at least one of LiCoO₂, LiVO₃, LiMn₂O₄, and LiFePO₄.

The cathode 110 is separated from the anode 114 by the electrolyte layer 112. The electrolyte layer 112 facilitates the flow of ions, such as lithium ions, between the cathode and the anode. Lithium phosphorus oxynitride (LiPON) is an amorphous glassy material that may be used as to form electrolyte the electrolyte layer 112, though any currently known or future material suitable for use as an electrolyte in a thin-film solid state battery may be used.

As illustrated, an anode 114 is deposited, on the top-side of the electrolyte layer 112 and the top-side of the anode contact 116. In other embodiments the anode itself acts as the contact point for the anode 112. In some embodiments the anode 114 is lithium, or another material containing lithium.

The illustrated battery 100 includes a separate anode contact 112. The anode contact 112 may be a conductive metal, such as nickel, or a conductive paste or ink. It should be noted that, while the anode contact and the cathode contact are located on the same side of the substrate in the example illustrated embodiment, they need not be on the same side of the substrate. It will further be appreciated that the illustrated battery 100 is only one example architecture, and other architectures and materials are contemplated.

The battery additionally includes an adhesive layer 118. In aspects, the adhesive layer 118 provides a means to adhere another thin-film battery and/or cover using an adhesive. In aspects of the technology, the adhesive layer 118 is disposed on portions of the top side of the anode 114, portions of the anode current collector 116, the cathode current collector 108, and the substrate. The adhesive layer 118 may be a press sensitive adhesive (either polyisobutylene, acrylate, and/or silicone type), polyisobutylene, urethanes, thermal cured epoxies, ultra violate cured epoxies, or low temperature glass seals.

The adhesive layer may be non-continuous such that portions of the adhesive layer 118 are absent. For example, vias 120 may penetrate through the adhesive layer 118, which vias may expose the anode current collector 116 and/or the cathode current collector 108 to other thin-film batteries (such as other thin-film battery of a cell stack). This may allow the anode current collector 116 and/or the cathode current collector 108 to be electrically coupled to an electrical device and/or another battery. The vias 120 may be formed using a variety of methods such as laser etching, chemical etching, or mechanical etching.

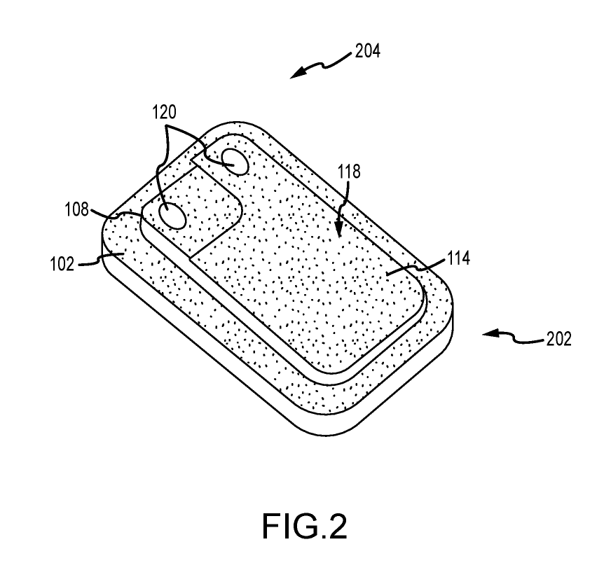

FIG. 2 illustrates a perspective view of a thin-film battery 200 with adhesive layer 118. It will be appreciated that elements like numbered as those in FIG. 1 will have the same or similar properties as those like numbered elements described with reference to FIG. 1. FIG. 2 includes a thin-film substrate 102 upon which a cathode current collector 108, and an adhesive layer 118 (illustrated by dotted layer), collectively referred to as a thin-film battery 200. The thin-film battery has a top surface 204.

The adhesive layer 118 may cover substantially all or a portion of the surface 204 of the thin-film battery 200. For example, the adhesive layer 118 may be applied to just the edges 206 of the thin-film battery 200 (e.g., just the exposed top-side of the substrate 102). In other embodiments, portions of the cathode current collector 108, the anode 114 may be covered by the adhesive layer 118. Indeed, the coverage of each of these layers may be up to or greater than 10%, 20%, 30%, 40%, 50%, 60%, 70%, 80%, 90, % and 95%. As illustrated the adhesive layer 118 covers a substantial portion of the surface 204 of the thin-film battery 202. Indeed, as illustrated, the vias 120 remain the only area of the surface area 204 that is not covered by the adhesive layer 118.

Covering a substantial portion of the surface area 204 may aid in adhering another cell (such as another thin-film battery) to the thin-film battery 200. For example, another thin-film battery may be oriented such that a desired electrical connection is formed when the thin-film battery 202 is adhered to the other battery. This may be accomplished aligning the vias 120 with vias of the other battery. Additionally, covering a substantial portion of the surface 204 with the adhesive layer 118 may also aid in mechanical stability. For example, the thin-film battery 200 may be flexed during usage. Having the adhesive layer 118 cover a substantial portion may allow the battery to be flexed without the layers coming apart. Additionally/alternatively, the adhesive layer 118 may increase the point loading and overall bendable properties of the thin-film battery 200.

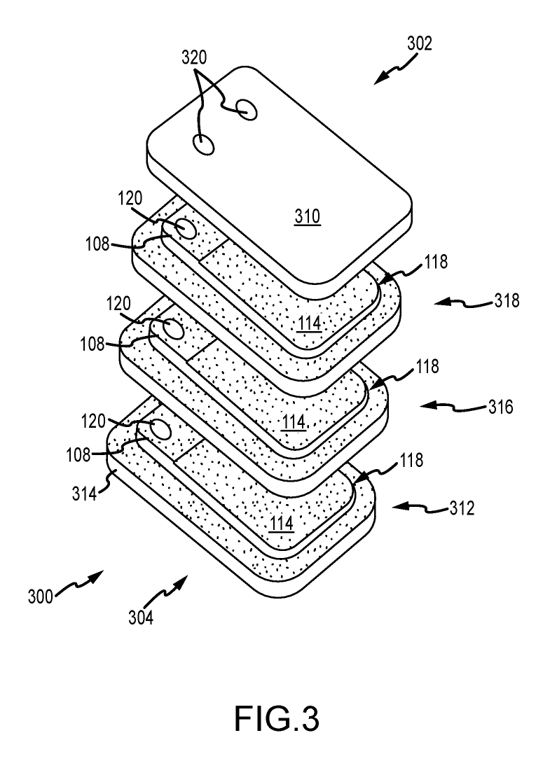

FIG. 3 illustrates an exploded view of a plurality of thin-film batteries in a cell stack 300. The cell stack has a top-side 302 and a bottom-side 304. The top-side 302 comprises a top-cover 310. A thin-film may comprise the cover 310, which may be used as the protective layer (e.g., the packaging). In some embodiments, the cover 310 may be a thin-film battery having a substrate, which substrate is used as the cover 310. As illustrated, the cover has vias 320 to allow electrical connection to the battery cell stack 300.

Similarly, the bottom-side 304 comprises a bottom thin-film battery 312. The bottom thin-film battery 312 includes a substrate 314. In aspects of the technology, the substrate 314 serves as the protective layer (e.g., the packaging).

The bottom thin-film battery 312, the first thin-film battery 316, and the second thin-film battery 318 each are illustrated as having an anode 114, a cathode current collector 108, adhesive layers 118, and vias 120. It will be appreciated that like numbered elements will have the same or similar properties as those like numbered elements described above.

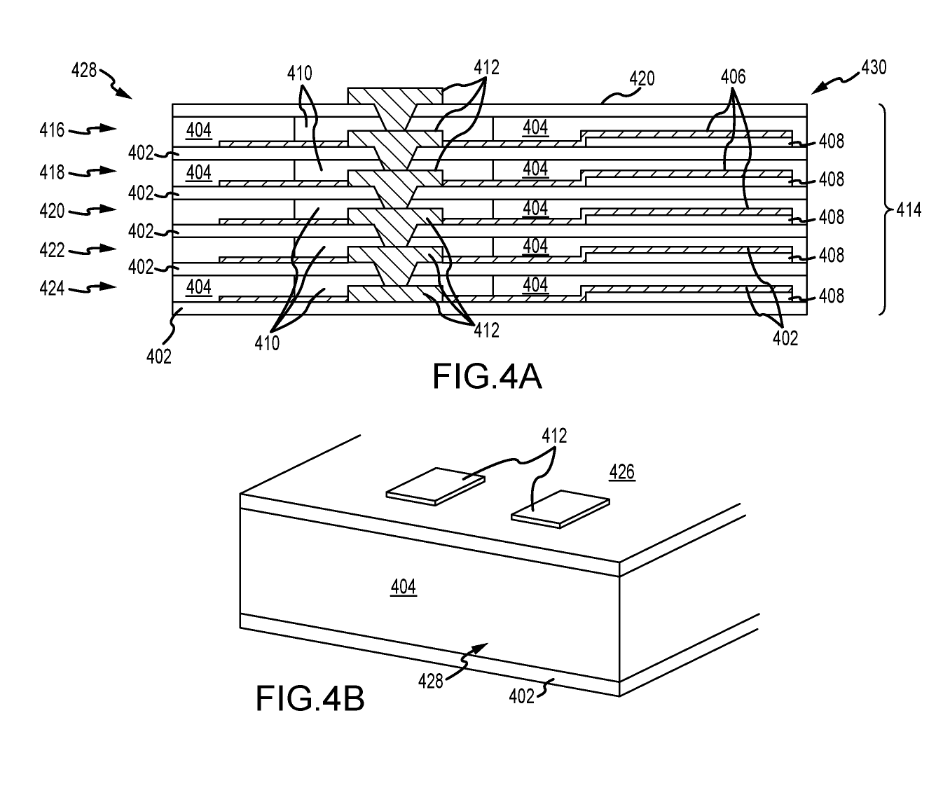

FIGS. 4A-8B illustrate various embodiments of via connections in thin-film battery cell stacks. As described further below, a via provides an electrical connection between one or more battery layers of a thin-film battery cell stack and/or provides an electrical connection point. For example, a via may be made of an electrically conductive material. The via may form a connection with a current collector (and/or a cap/via) from one battery layer of the thin-film stack. The via may additionally form a connection with a current collector (and/or a cap/via) from another battery layer of the thin-film stack. Further, the via may penetrate a cover of the thin-film stack and form a connection (or be a part of) a cap disposed on the cover of the cover. Caps may be disposed on the top surface of the cover to allow electrical connectivity with a device. The current collector may be either a cathode current collector or an anode current collector, similar or the same as those described above with references to FIGS. 1-3. In this way, the various layers of a thin-film battery stack may be connected in series and/or parallel.

FIG. 4A illustrates a cross-section and FIG. 4B illustrates a perspective view of a cell stack 400 with an adhesive layer material 404 and vias 412. As illustrated, a plurality of thin-film batteries 414 include a first thin-film battery 416 disposed on top of a second thin-film battery 418. The second thin-film battery 418 is disposed on top of a third thin-film battery 420. The third thin-film battery 420 is disposed on top of a fourth thin-film battery 422. The forth thin-film battery 422 is disposed on top of a fifth thin-film battery 424. A cover 426 is also illustrated.

Each of the first thin-film battery 416, the second thin-film 418, the third thin-film battery 420, the fourth thin-film battery 422, and the fifth thin-film battery 424 includes an active battery layer 408, which active battery layer 408 comprises a cathode, an electrolyte, and an anode. Additionally, each thin-film battery of the cell stack 400 is illustrated as having a substrate 402, a current collector 406, and an adhesive layer 404. It will be appreciated that the substrate 402, the active battery layer 408, the current collector 406, and the adhesive layer 404 may have the same or similar properties as those described above.

The current collector 406 may be in electrical contact with either the anode or cathode. It will be appreciated that, for each thin-film battery in the plurality of thin-film batteries 414, there may be another current collector, which is not shown, that is in electrical contact with either the cathode or anode. The current collector 406 serves to electrically connect one active battery layer 408 of one thin-film battery to another active battery layer 408 of another thin-film battery.

As illustrated, the adhesive layers 404 form a seal on a first edge 428 and a second edge 430 of the thin-film battery cell stack 400. In embodiments, the adhesive layers 404 may be electrically insulating. In such an embodiment, this deters electrical conductivity from occurring at the first edge 428 and the second edge 430 of the thin-film battery.

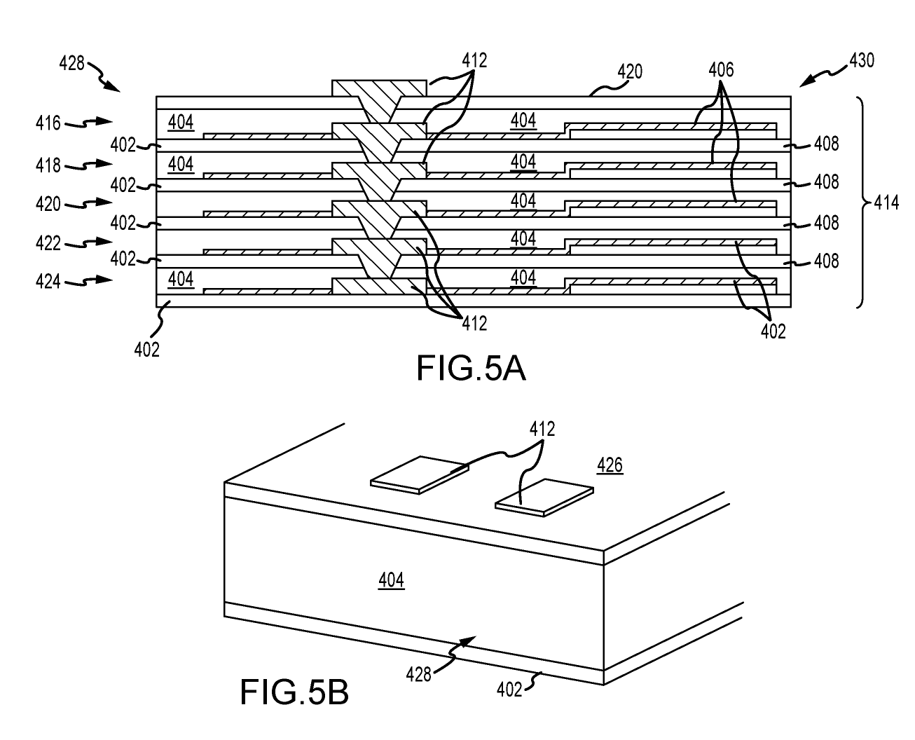

As illustrated, a void 410 is present in each adhesive layer 404. Such a void may be formed in a variety of means. For example, chemical etching, laser etching, or mechanical etching may be used to remove a portion of the adhesive layer 404. The presence of the void 410 may allow the vias 412 to establish a robust electrical connection on a via 412 below or above the thin-film battery layer. In other embodiments, there is no void. For example, FIG. 5 illustrates an embodiment where no void is present. It will be appreciated that elements of FIG. 5 that are like numbers as those illustrated in FIG. 4 have the same or similar properties as the elements described with reference to FIG. 4.

The vias 412 serve to provide electrical communication between the plurality of thin-film batteries 414. The via may have a substantially flat surface that is adapted to form a flush coupling with the via 412 of the thin-film battery. For example, the first thin-film battery 416 may have a via 412 that penetrates through the depth of the substrate 402 of the first-thin-film battery 416 and makes contact with the via 412 of the second thin-film battery 418. This couples the electrical current collector 406 of the first thin-film battery 416 with the electrical current collector 406 of the second thin-film battery 418. Indeed, each thin-film battery of the plurality of thin-film batteries 414 may be in electrical communication with the thin-film battery above/below it through the use of vias 412.

The via 412 may be a made of a conductive material. In aspects of the technology, a conductive epoxy serves as the via 412 to electrically couple the plurality of thin-film batteries together.

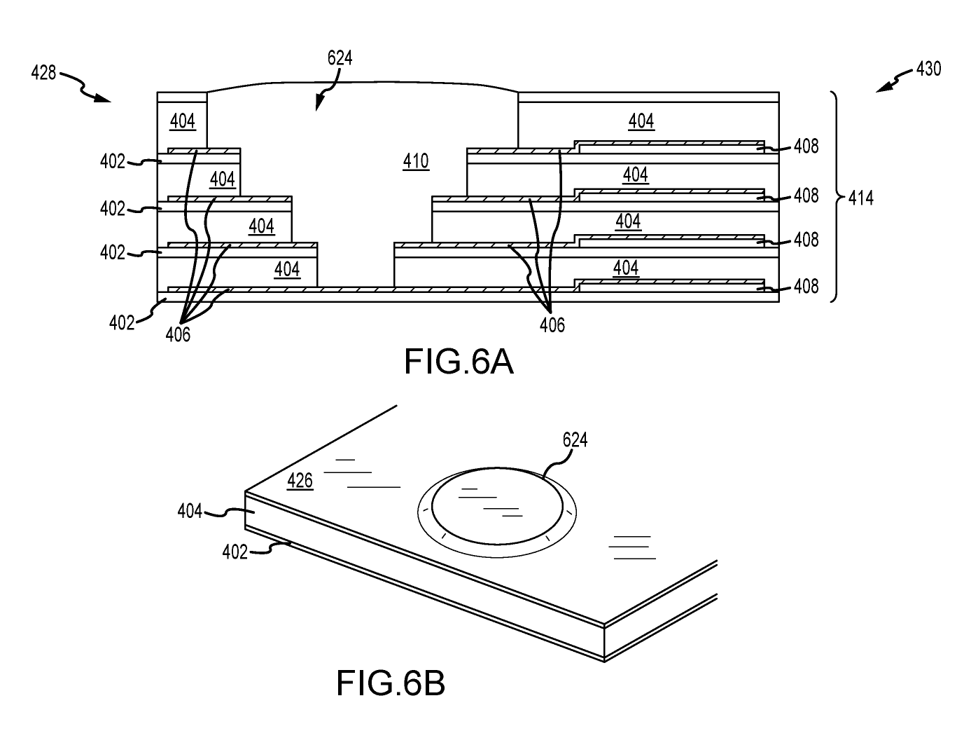

FIG. 6A illustrates a cross section view and FIG. 6B illustrates a perspective view of an example of a thin-film battery stack 600 with a stepped via. As illustrated, a plurality of thin-film batteries 414 includes a first thin-film battery 416 disposed on top of a second thin-film battery 418. The second thin-film battery 418 is disposed on top of a third thin-film battery 420. The third thin-film battery 420 is disposed on top of a fourth thin-film battery 422.

Each battery of the cell stack 600 is illustrated as having a substrate 402, an active battery 408, and a current collector 406, and an adhesive layer 404. It will be appreciated that like numbered elements of have the same or similar properties as those described above with reference to FIGS. 4 and 5.

A stepped via 624 has been formed in the thin-film battery. The stepped via 624 may join multiple current collectors together. For example, the stepped via 624 may be formed such that each current collector 406 from a first thin-film battery 416, a second thin-film battery 418, a third thin-film battery 420, and a fourth thin-film battery 422 are electrically connected.

The stepped via 624 may be formed in a variety of means. For example, the stepped via may be formed by first forming a thin-film battery cell stack 600 and then removing one or more layers from a portion of the resulting thin-film cell stack 600. Removal may occur through chemical etching, laser etching, or mechanical etching. Other means of removing a thin-film is contemplated. The resulting void may then be filed with a conductive paste or ink to form the stepped via 624.

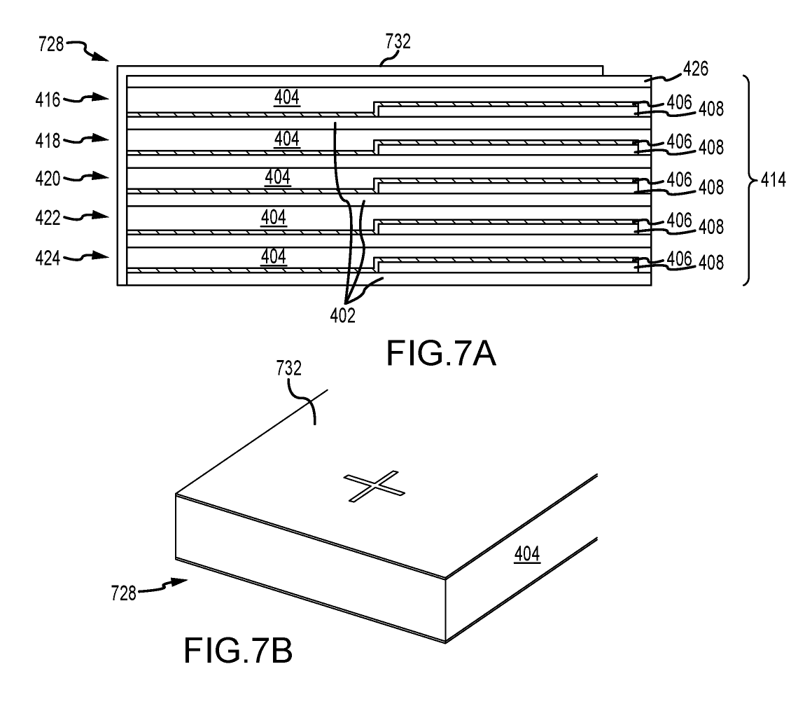

FIG. 7A illustrates a cross section and FIG. 7B illustrates a perspective view of a thin-film battery with end-cap metallization. As illustrated, a plurality of thin-film batteries 414 includes a first thin-film battery 416 disposed on top of a second thin-film battery 418. The second thin-film battery 418 is disposed on top of a third thin-film battery 420. The third thin-film battery 420 is disposed on top of a fourth thin-film battery 422. The forth thin-film battery 422 is disposed on top of a fifth thin-film battery 424. A thin-film battery cover 426 is also illustrated.

Each battery of the cell stack 700 is illustrated as having a substrate 402, an active battery layer 408, and a current collector 406, and an adhesive layer 404. It will be appreciated that like numbered elements of have the same or similar properties as those described above with reference to FIGS. 4, 5, and 6.

The cell stack 700 may have one or more sides with exposed current collectors. For example, the current collectors of cell stack 700 may have a first side 728 with expose current collectors 406. As illustrated, for each of the plurality of thin-film batteries, the adhesive layer 418 does not extend to the end of the substrate 402. Rather, the first side 728 has one or more current collectors 406 that are flush to a substrate 402.

The first side 728 allows for, in embodiments, a metallization layer 732 to be disposed over the exposed current collectors 406. As illustrated, the metallization layer 732 is a layer that is disposed on the exposed side 728 and forms an electrical connection with the current collectors 406. Additionally, the metallization layer 732 is disposed on the thin-film-battery cover 426. This may facilitate an electrical connection with a device. Other sides of the thin-film cell stack may not have exposed current collectors.

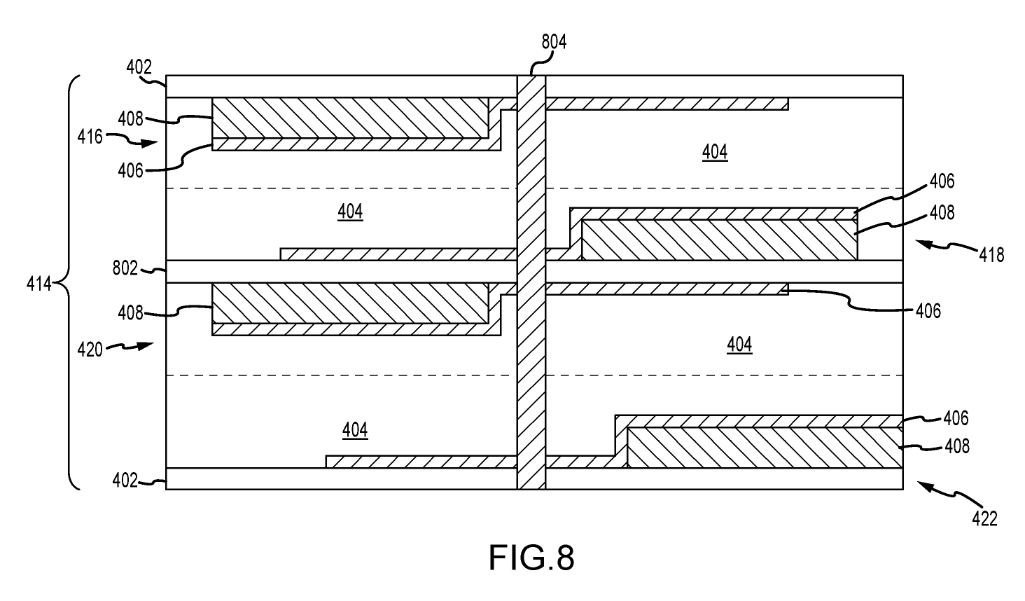

FIG. 8 illustrates a cross section view of an embodiment of a cell stack 800 with a dual sided substrate 802.

As illustrated, a first thin-film battery 416 is disposed on the adhesive layer of a second thin-film battery 418. That is, the adhesive layer 404 of the first thin-film battery 416 is in physical contact with the adhesive layer 404 of the second thin-film battery 418 (a dashed-line indicates the separate layers, though it will be appreciated that the two layers may form one continuous layer). As illustrated, the second thin-film battery 418 is disposed on top of the top-side of a duel-sided substrate 802. Disposed on the bottom-side of the dual-sided substrate 802 is a third thin-film battery 420. The third thin-film battery 420 is disposed on top of the fourth thin-film battery's 422 adhesive layer. That is, the adhesive layer 404 of the third thin-film battery 420 is in physical contact with the adhesive layer 404 of the fourth thin-film battery 422 (a dashed-line indicates the separate layers, though it will be appreciated that the two layers may form on continuous layer).

Each battery of the cell stack 800 is illustrated as having a substrate 402, an active battery layer 408, and a current collector 406, and an adhesive layer 404. It will be appreciated that the substrate 402, the active battery layer 408, the current collector 406 may have the same or similar properties as those described above. It will be appreciated that like numbered elements of have the same or similar properties as those described above with reference to FIGS. 4, 5, 6, and 7. Additionally illustrated is a via-connect 804. The via connect 804 spans the height of the cross section, as illustrated. That is, in embodiments, the via-connect 804 spans from a top-side of first thin-film battery 416 substrate 402, through the dual-sided substrate 802, and to the bottom side of the substrate 402 of the fourth-thin film substrate. Additionally, the via-connect 804 electrically couples a current collector 406 of the first thin-film battery 416 to each current collector of a second thin-film battery 418, a third thin-film battery 420, and a fourth thin-film battery 422.

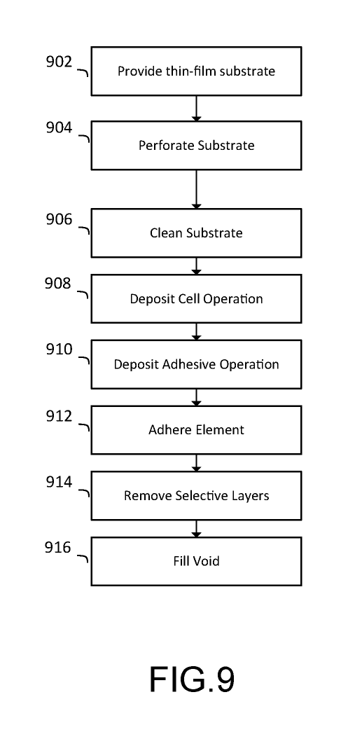

FIG. 9 is a method 900 to produce a thin-film battery with an adhesive layer. Method 900 begins with provide thin-film operation 902. The thin-film may be wafer or wafer like material made of insulating material such as aluminum oxide, yttria stabilized zirconia, glass, etc. The wafer material may be chosen from a material that blocks the transport of water vapor and oxygen to the battery materials. The material may be any shape, including a round or square format. The thin-film may have a total thickness of 100 microns or less, and in some embodiments has a total thickness of 50 microns or less, 25 microns or less, or 10 microns or less. Alternately a thick wafer may be used and polished down to a thickness less than 100 microns after the battery is complete, or in some embodiments less than 50 microns, less than 25 microns, or less than 10 microns.

Method 900 then proceeds to perforate substrate operation 904. In operation 904, substrates may be perforated and laser holes drilled prior to coatings to support subsequent segmentation of individual cells from larger sheets. Individual cell areas may be of any size, and in some embodiments are in the range from 1 mm² to 100 cm². In embodiments, individual cell areas may be less than 1 mm², or greater than 100 cm². In aspects, laser vias with diameter from 20 microns to 2 mm may be drilled into the substrate. In some embodiments, laser vias may have a diameter less than 20 microns, less than 10 microns, or less than 5 microns. In other embodiments, laser vias may have a diameter greater than 20 microns, greater than 50 microns, greater than 100 microns, greater than 200 microns, greater than 500 microns, greater than 1 mm, or greater than 2 mm. The vias may subsequently be used as to interconnect the anode current collector of one cell with the anode current collectors of other cells within the battery stack. A similar via may be used to interconnect the cathode current collectors. In aspects of the technology, substrates may be cut to final cell dimensions and laser holes may be drilled prior to coating. Additionally, vias may be pre-drilled.

Method 900 proceeds to clean thin-film operation 906. In operation 906, a thin-film is cleaned. In aspects, cleaning removes debris and/or contaminates. To perform the cleaning, techniques such as plasma etching, high temperature heat treatments, or wet chemical cleaning (such as RCA solutions) may be used.

Method 900 then proceeds to deposit cathode current collector operation 908. In operation 908 a cathode current collector is deposited. The cathode current collector may include cobalt, gold, nickel, titanium, chromium, platinum, palladium, tungsten, copper or alloys. Further, the current collector may overlap a laser via. In aspects, the current collector is between 0.1 to 1 micron thick. In aspects, the current collector is less than 0.1 micron thick, or greater than 1 micron thick. In aspects, the cathode current collector is deposited using either lift-off or etch back resists to create an area equal to or slightly larger than the desired active area for the thin-film battery, e.g. on the order of 0-20 microns larger on all sides. In some embodiments, the cathode current collector is less than 5 microns larger on all sides, less than 10 microns larger on all sides, less than 20 microns on all sides, or less than 50 microns on all sides.

Adhesion layers and/or diffusion barriers may be deposited between the wafer and the cathode current collector such as Ti, Co, Cr, etc. The adhesion/diffusion barriers may have a thickness less than 0.5 microns, less than 1 micron, less than 2 microns, less than 5 microns, less than 10 microns, or greater than 10 microns. The cathode current collector may be deposited using techniques such as atomic layer deposition, chemical vapor deposition, plasma deposition and/or plasma enhanced chemical vapor deposition

In aspects, a hole may be drilled in the wafer prior to patterning of the cathode current collector to facilitate the connection of the cathode current collector through the wafer to the external electronic device using a via. In these cases, there may be a contact pad patterned near the cathode current collector on the opposite side of the wafer and the contact pad and cathode current collector may be electrically connected by either a thin-film deposition or filled with a conductive metal, conductive epoxy, conductive ink, etc. In additional/alternative embodiments, the cathode current collector area may have a tab slightly larger than subsequent battery layers to facilitate a means to contact to the positive terminal of the battery after fabrication is complete.

Method 900 then proceeds to deposit cathode operation 910. In operation 910, a cathode layer is deposited and patterned. The cathode layer may be lithium cobalt oxide, lithium vanadium oxide, lithium nickel oxide, lithium manganese oxide, lithium iron oxide or alloys thereof. The cathode layer may have a thickness from 1-20 microns, and in some embodiments is less than 5 microns, less than 10 microns, less than 20 microns, or greater than 20 microns. In aspects, the cathode is patterned with lithography. The cathode may be annealed to high temperatures to establish a preferred crystal structure. The annealing step may be done before the resist is applied (etch back) or after the resist is removed (lift-off). The cathode may also be heat treated at a temperature from 300 to 800° C. to attain a desired crystal structure.

Method 900 then proceeds to deposit electrolyte operation 912. In operation 912, the electrolyte 912 is deposited and patterned. In aspects of the technology, the electrolyte may be made of thin-film glassy materials such as LiPON, lithium aluminum fluoride, lithium phosphorous oxynitride, lithium lanthanum zirconate, lithium aluminum titanium phosphate, etc. and may have a thickness from 0.2 to 3 microns thick. In some embodiments, the electrolyte has a thickness less than 0.2 microns, less than 1 micron, less than 2 microns, less than 3 microns, or greater than 3 microns. The electrolyte may be deposited using a variety of means including sputtering deposition and/or evaporation. In aspects of the technology, the LiPON layer may occupy a larger surface area on the thin-film than the cathode. In some embodiments, this reduces shorting of the electrode. The electrolyte may be patterned with lift-off or etch back photolithography.

The method 900 then proceeds to deposit the anode operation 914. In operation 914, an anode may be deposited. For example, a lithium metal anode of 0.2 to 3 microns thick may be deposited. The anode may have a thickness less than 0.2 microns, less than 1 micron, less than 2 microns, less than 3 microns, or greater than 3 microns. Alternatively or additionally, a lithium free anode may be deposited where a thin metal or thin metal film stack are deposited directly on LiPON. Lithium free materials may include Cu, Ni, Ti, Si and/or silicon alloys. Lithium free layer thickness may range from from 0.2 to 2 microns, or may have a thickness less than 0.2 microns, less than 1 micron, less than 2 microns, less than 3 microns, or greater than 3 microns.

The method then proceeds to deposit anode collector operation 916. In deposit anode current collector operation 916, a thin metal or thin metal stack may be deposited. The total stack thickness may range from 100 to 6,000 angstroms. Metals of the anode current collector may include cobalt, gold, nickel, titanium, chromium, platinum, palladium, tungsten, copper or metal alloys. The anode current collector may overlap the laser via. The anode current collector may have a surface area that is greater than (and extends beyond foot print, in embodiments of) the cathode, electrolyte, and/or anode. In aspects, this may allow for to the base of the wafer to allow for contact to the external electronic device through vias/holes in either the substrate or a top cover (which may be another battery cell on a substrate, or may be another substrate).

The method 900 then proceeds to deposit adhesive operation 918. In operation 918, the adhesive may be deposited over an anode current collector, an anode, an electrolyte, a cathode, and/or a cathode current collector. In aspects, the adhesive is deposited over one or more cells of a previously deposited SSB (such as a SSLB). The adhesive may be deposited using a variety of methods including spin coating, dip coating, spray coating, etc. In some aspects, the adhesive operation has a total thickness <20 microns. In other aspects, the adhesive operation has a total thickness less than 5 microns, or less than 10 microns. The adhesive layer may be chosen from a class of patternable materials such as UV cured epoxies, spin on polyimide materials, etc. In aspects of the technology, the adhesive layer may be patterned to an area larger than the cathode, the electrolyte, the cathode current collector, the anode current collector, and/or the anode, each/all of which may have been deposited on a thin-film substrate. The adhesive layer may be patterned before and/or after the application of the cover sheet. The adhesive layer may be chosen from a class of epoxies, urethanes, rubbers, silicones, polyimides, cyanoacrylates, acrylics, pressure sensitive adhesives or other materials that may be patterned by selective removal processes such as chemical etching, plasma etching, etc. In aspects, operation 918 may include placing a thin bead of sealing material around the edge of the cell substrate area.

The sealing material may provide not only sealing of substrates together, but also may serve as an environmental barrier layer. Sealing materials may have water vapor transport rate less than 0.0001 g/m²-day, and in some embodiments less than 0.00001 or 0.000001 g/m²-day. Sealing material thickness may range from 50-500% of total battery materials thickness. The substrate material may not only serve as the substrate, but also serve as an environmental barrier. The substrate may have water vapor transport rate less than 0.001 g/m²-day, and in some embodiments less than 0.0001 g/m²-day or 0.00001 g/m²-day.

The method 900 then proceeds to adhere an element operation 920. In aspects, an element may be another thin-film battery. Indeed, the other thin-film battery may have perforations in the substrate. Those perforations may be designed to receive an electrically conductive material to enable the thin-film battery to be in electrical communication (e.g., electrically coupled) with the battery components (such as the anode, the electrolyte, the cathode, the anode current collector, and/or the cathode current collector) discussed with reference to operations 902-918. Additionally/Alternatively, the element may be a cover, such as a substrate, which protects the battery components discussed with reference to operations 902-918. The cover may have perforations that are adapted to receive an electrically conductive material such that the battery components (such as the anode, the electrolyte, the cathode, the anode current collector, and/or the cathode current collector) may be electrically coupled to a device and/or another battery. For example, both a cover and a battery may have perforations through a substrate to a current collector (e.g., an anode current collector and a cathode collector) such that filling the perforation with a conductive material may create a via from the current collector, through the substrate.

With respect to a cover sheet, the cover sheet may be a thin insulating material that is applied over the adhesive layer. The cover sheet may be chosen from materials such as aluminum oxide, yttria stabilized zirconia, and glass. The cover sheet may block the diffusion of moisture and oxygen to the battery materials. The cover sheet may have a thickness less than 100 microns. In some embodiments, the cover sheet has a thickness less than 50 microns or less than 20 microns. Alternately, a thicker cover may be employed and subsequently thinned. UV light, pressure and/or heat may be applied to help create an effective bond between the cover and adhesive. The cover may be a substrate.

The method 900 then proceeds to remove selective layers operation 922. In operation 922, portions of the adhesive layer, the substrate, the anode, the anode current collector, the cathode, the electrolyte layer, and/or the cathode current collector may be removed. Removal may be determined in anticipation of aligning the resulting exposed via to the perforations of the adhered element discussed above with reference to operation 920. For example, an adhesive layer may be removed that corresponds to the perforations formed in operation 904. This may form a hole (e.g., a void or cutaway) that exposes the anode current collector, the cathode current collector, the anode, and/or the cathode described with reference to operations 916, 908, 914, and 910 respectively.

Method 900 then proceeds to fill void operation 924. In 924, the voids created in operation 922 are filled with a conductive material, such as a conductive epoxy or ink.

The method may be repeated multiple times. This may result in stacking and sealing individual cells one at a time or a plurality of cells together to create a battery with the desired number of cells. In aspects, a pressure is applied as needed to minimize trapped air between cells. Packaging may also include connecting cells together and to battery terminals by filling the holes or opening with an electrically conducting material to form a via. The interconnection materials may be chosen from conductive epoxies, liquid metals or alloys that solidify after the holes are filled, solders, etc. In aspects, the interconnection resistance is <100 Ohms through the entire stack. Further, the design may be such that an anode and cathode battery terminals are electrically isolated from each other.

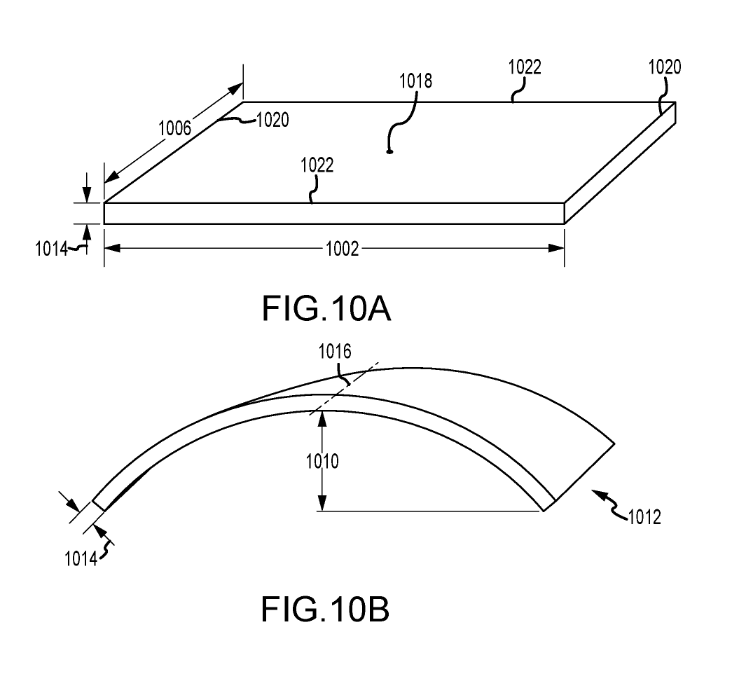

FIG. 10A and FIG. 10B illustrate a view of an un-flexed and flexed multi-cell, thin-film battery. While the battery is illustrated as a rectangular prism, it will be appreciated that a plurality of thin-film batteries may be present, and may be stacked and connected using the technology, described herein. The battery 1000 may include one or more adhesive layers as described herein.

The illustrated battery has a length 1008, a width 1006, a surface area defined by the length times the width, a depth 1004, and a flex radii 1010. The flex radii 1010 is measured by bending two opposite edges of the thin-film battery 100 (such as 1012 and 1014) such that the battery 1000 bends at a center line 1016, the center line 1016 crossing at or near the center point 1018 of the surface area of the battery 1000. The center line 1016, in aspects where the thin-film battery is a rectangular prism, may be parallel to edges 1020 and orthogonal to an edges 1022. The distance the center point 1018 is from a plane formed by edges 1020 is referred to herein as the flex radii 1010.

Is aspects of the technology, the battery has a depth 1004 of less than 0.01 inches, a width 1006 of around 2 inches, and a length 1008 of around 3 inches. The active battery area (i.e., the active cell area) may have a foot print of about 60-70% of the surface area of the battery 1000.

In aspects, the battery 1000 may have between 2-30 battery cells (e.g., a cathode, an anode, an electrolyte, an anode current collector, and a cathode current collector). The battery capacity may be between 50 mAh to 500 mAh or higher. Voltages of the battery may range from 1.5 to 3.6V or higher.

In aspects, the battery may have a gold cathode connect, an LiCoO2 cathode, a LiPON electrolyte, a lithium anode, and a nickel lithium anode connect. In aspects of the technology, a pressure sensitive adhesive (either polyisobutylene, acrylate, and/or silicone type), polyisobutylene, urethanes may be used in an adhesive layer. The adhesive layer may cover all or substantially all of a thin-film battery. In such embodiments, the flex radii 1010 may be high. For example, in a battery 1000 with a surface are of around 40 cm², with a length 1008 of 8.5 cm, the flex radii 1010 may be around 1 inch to 2 inches (or greater). In further embodiments the flex radii 1010 may be higher.

In aspects of the technology, water vapor transfer rates may be reduced to as low as W as low as 1.3E-4/m²-day at 85° C. and 85% relative humidity. In aspects, water vapor transfer rates are reduced below 1.3E-4/m²-day at 85° C. and 85% relative humidity. Stable resistance at greater than 150 hours at 85° C. and 85% relative humidity may also be achieved using the embodiments described herein. Indeed, lithium batteries using the technologies described herein may result in less than 1% lithium loss at 5 years and less than 3% lithium loss at 20 years during battery use. This demonstrates superior packaging characteristics.

It will be appreciated that battery may consist of a single cell with a cover sheet and edge seal. A battery may consist of multiple cells stacked vertically and connected in series or parallel with a cover sheet. The cover sheet may be a thin substrate with battery coatings with the battery coatings oriented toward the interior of the battery package.

1. A battery comprising:
a substantially planar thin-film substrate having a top-side and a bottom-side;
a cell disposed on the top-side of the substrate, the cell comprising a cathode current collector, a cathode, an anode current collector, an anode, and an electrolyte, wherein the cell has a top-side; and
an adhesive layer disposed on and coupled to at least a portion of the top-side of the cell.

2. The battery of claim 1, further comprising:
a second substrate disposed on a top-side of the adhesive layer, the second substrate having a second top-side;
an second cell disposed on the second top-side, the second cell comprising a second cathode, a second cathode current collector, a second anode current collector, a second anode, and a second electrolyte; and
a via that electrically couples the anode current collector or the cathode current collector to the second cathode collector or the second anode collector, wherein the via is filled with a conductive material;

3. The battery of claim 1, wherein a third cell is disposed on the bottom-side of the thin-film substrate, wherein the third cell is in electrical communication with the cell.

4. The battery of claim 1, wherein the adhesive layer is at least one of an epoxy, a urethane, or a rubber.

5. The battery of claim 1, wherein the cathode is at least one of LiCoO2, LiVO3, LiMn2O4, and LiFePO4.

6. The battery of claim 1, wherein the anode current collector or the cathode current collector is exposed at an edge, and further wherein an end-cap metallization layer is disposed on the exposed anode current collector or the cathode current collector.

7. The battery of claim 1, wherein the battery has flex radii of greater than 5 millimeters.

8. A battery comprising:
a substantially planar thin-film substrate having a top-side, a bottom-side, and an edge;
a cathode current collector having a cathode current collector top-side and a cathode current collector bottom-side, the cathode current collector bottom-side disposed on and coupled to at least a portion of the top-side of the thin-film substrate;
a cathode having a cathode top-side and a cathode bottom-side, the cathode bottom-side disposed on and coupled to at least a portion of the cathode current collector top-side;
an electrolyte layer having an electrolyte layer top-side and an electrolyte layer bottom-side, the electrolyte layer bottom-side disposed on and coupled to at least a portion of the cathode top-side;
an anode having an anode top-side and an anode bottom-side, the anode bottom-side disposed on and coupled to at least a portion of the electrolyte layer top-side;
an anode current collector having an anode current collector top-side and an anode current collector bottom-side, the anode current collector bottom side disposed on and coupled to at least a portion of the anode top-side;
an adhesive layer having an adhesive layer-top side and an adhesive layer bottom side, the adhesive layer bottom-side disposed on and coupled to at least a portion of the anode current collector top-side, the cathode current collector top-side, and the top-side of the thin-film substrate.

9. The battery of claim 8, further comprising:
a second thin-film substrate having a second-top side and a second bottom-side, the second bottom-side disposed on and coupled to at least a portion of the top-side of the adhesive layer top-side;

10. The battery of claim 9, wherein a battery cell is disposed on and coupled to the second top-side, the battery cell in electronic communication with the anode current collector or the cathode current collector, the electronic communication facilitated by a via.

11. The battery of claim 10, wherein the via comprises a pathway that extends from at least the anode current collector or the cathode current collector, through the adhesive layer, and through the second thin-film substrate such that the via is in electrical contact with a current collector of the battery cell.

12. The battery of claim 11, wherein the via is a stepped via.

13. The battery of claim 10, wherein the via comprises a metallized end-cap that is coupled to the edge of the thin-film substrate, and further wherein the anode collector or the cathode collector extends along the top-side of the thin-film substrate to the edge of the thin-film substrate such that the anode collector or the cathode collector is in electrical contact with the metalized end-cap.

14. The battery of claim 8, wherein the adhesive layer is at least one of an epoxy, a urethane, or a rubber.

15. The battery of claim 8, wherein the cathode is at least one of LiCoO2, LiVO3, LiMn2O4, and LiFePO4.

16. The battery of claim 8, wherein the battery has flex radii of greater than 5 millimeters.

17. The battery of claim 8, wherein the substrate comprises yttria stabilized zirconia.

18. A method of creating a solid state battery, the method comprising:
providing a substrate, the substrate having a top side and a bottom side;
depositing an anode current collector, an anode layer, an electrolyte layer, and a cathode current collector, and a cathode layer on the top-side of the substrate to form a first cell, the first cell having a top-side and a bottom-side;
placing an adhesive layer over at least a portion of the top-side of the first cell; and
sealing the first cell by adhering an element to the top side of the first cell, wherein the adhesive layer forms a seal with the element.

19. The method of claim 18, wherein the adhesive layer covers at least a portion of each of the anode, the anode current collector, and the cathode current collector.

20. The method of claim 19, wherein the adhesive layer covers at least 90% of the anode.

21. The method of claim 18, wherein the element is a thin-film battery, the thin-film battery comprising a plurality of cells, each cell of the plurality of cells deposited on a thin-film substrate.

22. The method of claim 18, wherein the battery has flex radii of greater than 5 millimeters.

23. The method of claim 18, wherein the first cell is in electronic communication with the plurality of cells through a via.

24. The method of claim 23 wherein the via comprises an end-cap metallization.

25. The method of claim 18, wherein the adhesive layer is at least one of an epoxy, a urethane, or a rubber.

26. The method of claim 18, wherein the cathode is at least one of LiCoO2, LiVO3, LiMn2O4, and LiFePO4.

27. The method of claim 18, wherein the anode current collector or the cathode current collector is exposed at an edge, and further wherein an end-cap metallization layer is disposed on the exposed anode current collector or the cathode current collector.

28. The method of claim 18, wherein the battery has flex radii of greater than 1 inch.
